(19) United States
(12) Patent Application Publication
(10) Pub. No.: US 2017/0109436 A1
(43) Pub. Date: Apr. 20, 2017

(54) APPARATUS AND METHOD FOR PROVIDING ALERTS FOR NETWORK DEVICE ERRORS AND FOR RESOLVING NETWORK DEVICE ERRORS

(71) Applicant: ARRIS Enterprises, Inc., Suwanee, GA (US)

(72) Inventors: Christopher S. DelSordo, Souderton, PA (US); Albert F. Elcock, West Chester, PA (US); Charles Hardt, Lawrenceville, GA (US)

(21) Appl. No.: 14/885,195

(22) Filed: Oct. 16, 2015

(51) Int. Cl. G06F 17/30; H04L 12/24; H04L 12/26; H04L 12/66

(52) U.S. Cl. CPC G06F 17/30696; H04L 12/66; H04L 41/22; H04L 43/0823; H04L 41/0686; G06F 17/30657; G06F 17/30675

(57) ABSTRACT

The device alert system includes a home gateway coupled to multiple customer premises equipment (CPE) devices. The home gateway monitors communications among the gateway and the CPE devices to detect errors and/or issues arising from use of the gateway or CPE devices. It also has access to textual information describing each of the CPE devices. The home gateway automatically generates a search query by converting the detected error and/or issue into a text string and combining it with the text information describing the CPE device for which the error and/or issue was detected. The home gateway then causes a search to be performed based on the search query and causes the results of the search to be parsed and compared to the query. The home gateway then presents the results of the search to the user to assist the user in resolving the error and/or issue.

### TECHNICAL FIELD

The present subject matter relates to techniques and equipment to provide a mechanism to alert the consumer of device failures experienced on the home network and to provide links to possible solutions to the problem.

### BACKGROUND

Today's consumer home network requires support for an increasing number of devices that connect to and communicate via a network. A global information network (e.g. the Internet®) is a rich source of information such as owner's manuals, service support, diagnostic error definitions and solutions to these errors. If searched properly, the Internet can provide resources that give step by step instructions on how to solve problems. Typically, however, the consumer must search the Internet and gather links to all this information. This can be a time consuming effort. Also, many consumers are not very savvy when it comes to searching the Internet for possible solutions to problems. Furthermore, the consumer may experience a problem but not know its source. Finally, they may not have sufficient information about the problem or its source to be able to describe the problem in a manner that would result in an effective search.

### SUMMARY

The concepts disclosed herein provide for a device alert system that senses the existence of an error or issue on a home network, and automatically performs Internet searches to acquire valuable diagnostics and solution information that can be used to help resolve the problem or issue. The device alert system includes a home gateway coupled to multiple customer premises equipment (CPE) devices. The CPE devices may include devices that communicate with the home gateway via wired or wireless connections. The home gateway monitors communications among the gateway and the CPE devices to detect errors and/or issues that the customer may have with the gateway or one of the devices. It also has access to textual information describing each of the CPE devices. The home gateway automatically generates a search query by converting the detected error and/or issue into a text string and combining it with the text information describing the CPE device for which the error/issue was detected. The home gateway then causes a search to be performed based on the search query and causes the results of the search to be parsed and compared to the query. The home gateway then presents the results of the search to the user to assist the user in resolving the error/issue.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a block diagram of an example home network environment.

FIG. 2 is a block diagram of a portion of the home network environment showing details of an example home gateway.

FIG. 2A is a block diagram of an example mobile device.

FIG. 3 is a block diagram useful for describing a second example home network environment.

FIG. 4 is a block diagram of a third example network environment.

FIG. 5 is a flow-chart diagram that is useful for describing the operation of the home networks shown in FIGS. 1-4.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various examples disclosed herein relate to methods and apparatus that provide the consumer with a mechanism that senses an error or issue existing on the home network, and automatically performs Internet searches to acquire valuable diagnostics and solution information that can be used by the consumer to help diagnose and resolve the problem. Errors may be indicated by a specific error message provided by a CPE device, by the home gateway not receiving an expected communication (e.g. loss of Internet connection), by the home network detecting an invalid configuration or by the user indicating an error or issue with the system. Customers may also have issues arising from the use of a CPE device, such as the inability to access pay-per-view content or the inability to determine how to use a feature of the CPE device. These issues are not errors but may benefit from the information obtained using the described system. These issues may also be automatically detected by the home gateway or may be indicated to the home gateway by the user. The results of the searches for information to help the user diagnose and resolve the error or issue may be delivered to the user in a configurable manner and the types of searches performed or the information returned to the user may be modified based on feedback received from the user.

In addition to recognizing errors or issues occurring in the gateway or CPE devices, the system may automatically locate and store service information, such as users manuals and/or service manuals for each of the gateway and CPE devices. As described below, this may be done automatically the first time the gateway is powered-up and whenever a new CPE device is added to the network.

There are several possible embodiments, the first embodiment provides support in a home gateway to automatically recognize errors or issues from a number of sources and translates each respective error or device issue into an appropriate text string that the gateway sends to a network server to perform automated Internet searches. The results of these searches are then processed by the server such that only the more strategic results related to the detected error or issue are sent to the user. These results are displayed on a CPE device selected by the user or by the system to receive the search results. Alternatively, rather than directly displaying the results on a CPE device, the server may add the results to a web page and send a message informing the user of the error or issue and giving the user instructions to retrieve the results of the search from the webpage.

The second embodiment accesses the Internet through the home gateway. In this configuration, the home gateway processes communications from a number of sources and monitors its own performance to identify errors or issues and translates the errors or issues into an Internet search string. The gateway then searches the Internet using the input string and causes the results to be displayed to the user.

In a third embodiment, the home gateway may be disconnected from the network. In this embodiment, the home gateway identifies the error or issue and provides pre-cached information to the user upon identifying an error or issue with the network connection or with a piece of equipment that is connected to the home gateway.

The term “coupled” as used herein refers to any logical, physical or electrical connection, link or the like by which signals produced by one system element are imparted to another “coupled” element. Unless described otherwise, coupled elements or devices are not necessarily directly connected to one another and may be separated by intermediate components, elements or communication media that may modify, manipulate or carry the signals. Each of the various couplings may be considered a separate communications channel.

Reference now is made in detail to the examples illustrated in the accompanying drawings and discussed below.

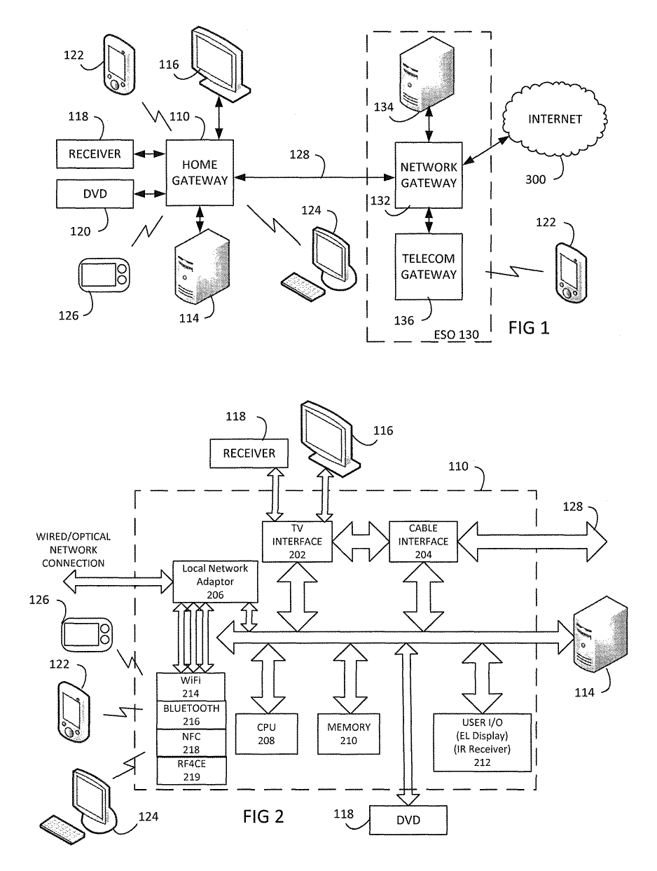

FIG. 1 is a block diagram illustrating an example network environment that can be part of a communications network that can be used as a broadcast, ATSC, IPTV or IP Video delivery network that transports or delivers data files and media content, including via multicast transmissions. The network environment can include an edge serving office (ESO) 130, which can be a headend or central office of a multiple service provider (MSO) such as a cable, satellite, or telephone company. The ESO 130 can contain various communications equipment, such as one or more modulation/demodulation devices (not shown), a content server (not shown), and other communications equipment (not shown) that can provide video, data, and/or voice service to a user. The communications equipment at the ESO 130 can be operable to communicate with one or more user devices through a home gateway 110. The user devices may be customer premises equipment (CPE) devices such as a network attached storage (NAS) device 114, a digital television (DTV) receiver 116, a radio receiver 118, a digital video disc (DVD) player 120 including a streaming video facility, a mobile device 122, a computer 124 or a thermostat 126 or other Internet of things (IoT) device (e.g. an appliance, surveillance camera, light fixture, etc.) that connects to the Internet through the home gateway. These CPE devices can be located at or near a user's premises. In the example system, CPE device 122 is a mobile device that may have wireless telecommunications capability, even though it is designated as a “customer premise” device. In FIG. 1, only particular CPE devices 114, 116, 118, 120, 122, 124 and 126 are shown for illustrative purposes, but more or fewer can be coupled to the ESO via the home gateway 110.

Still referring to FIG. 1, the communications equipment at the ESO 130 can communicate with one or more of the CPE devices 114, 116, 118, 120, 122, 124 and 126 through a transport network. Examples of ESO-to-Premises transport networks include one or more hybrid-fiber coaxial (HFC) networks and/or RF over Glass (RFoG) networks. An example HFC network can use a combination of optical fibers and coaxial cable as the network connection 128 to send data to and receive data from the communications equipment at the ESO 130. One or more RFoG networks can be deployed with existing HFC networks. RFoG networks typically include an all-fiber service from the ESO 130 to a field node, or home gateway 110, which is typically located at or near the user's premises. Coaxial cable can be used to connect the ONUs of an RFoG network to one or more user devices 114, 116, 118, 120, 122, 124 or 126. Additionally, any other wired or wireless networks can be used, including Passive Optical Networks (PON), Gigabit Passive Optical Networks (GPON), Digital Subscriber Line (DSL), Wi-MAX, or Ethernet.

In this example, the NAS device 114, DTV receiver 116, a radio receiver 118 may be coupled to the home gateway 110 via physical connections. The mobile device 122 may be coupled to the gateway 110 via a short-range radio frequency (RF), magnetic or optical connection (e.g. 802.11 WiFi, Bluetooth, Zigbee Radio Frequency for Consumer Electronics (RF4CE), near field communication (NFC) or infra-red (IR)), and the computer 124, thermostat 126 and DVD player 120, may be coupled to the home gateway 110 via a wired connection such as a universal serial bus (USB) cable, a FireWire cable, an Ethernet connection and/or via a short-range RF, magnetic or optical wireless connection. Each of these connections may be considered to be a separate communications channel.

In this example, the ESO 130 includes a network gateway 132 that provides access to a network server 134 and, optionally to other networks, such as the Internet, and a telecommunications gateway 136 that provides telecommunications access to CPE devices such as mobile device 122 that is also coupled to the home gateway 110 via the short-range RF, magnetic or optical connection. The ESO 130 may include data sources (not shown), that provide content to the CPE devices via a standard cable television connection or as an IPTV or IP Video delivery network. These data sources, for example, may be servers coupled to the network gateway 132 in the same manner as the server 134.

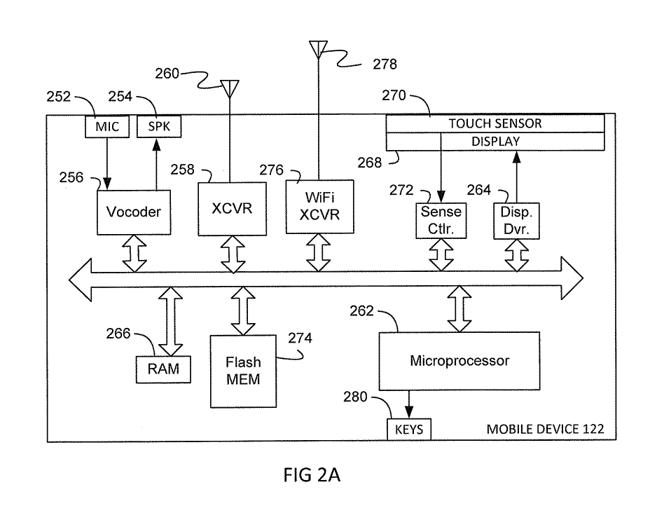

FIG. 2 shows a block diagram of an example home gateway 110 shown in FIG. 1. In this example, the home gateway 110 includes the functionality of a set-top box (STB). The combination of the STB and the home gateway may be referred to as a set-top gateway. It is contemplated, however, that the STB may be separate from the home gateway. In this instance, the home gateway provides the network connection and the STB provides the media functionality. When the STB is separate from the home gateway 110, the STB may be connected to the cable line 128 in parallel with the home gateway or may be connected to the home gateway 110 to receive IPTV packets from ESO 130 via the home gateway.

The example home gateway 110 shown in FIG. 2 includes TV interface 202 for processing data, e.g. decoding an MPEG transport stream to output visual content for display on DTV 116 and to stream audio content to DTV 116 and/or to radio receiver 118. The home gateway 110 also includes an interface for local communication with CPE devices. In this example, that interface takes the form of a local network adapter 206 which includes a wired/optical communication port as well as wireless ports to WiFi transceiver 214, Bluetooth transceiver 216, NFC transceiver 218 and Zigbee RF4CE transceiver 219. The example, WiFi channel 214 may be a WiFi access point.

The home gateway 110 also includes cable interface 204 for receiving programming and Internet protocol (IP) packets from the ESO 130. The IP packets may include encapsulated MPEG transport streams. The TV interface circuitry 202 may include circuitry that reconstitutes selected MPEG transport streams from the IP packets and sends the MPEG transport streams to the DTV device 116. The cable interface may also send and receive data over the network to/from the server 134 and/or a content server (not shown) to obtain the media content and possibly meta-data files or meta-data related instructions from the ESO 130. The home gateway 110 also includes circuits forming one or more processors to implement a CPU 208 and memory 210 for controlling operations of the home gateway, including performing the processing of the IP packets, media content and meta-data files. The example home gateway is connected to the NAS device 114 for storing the media content and meta-data files downloaded via the ESO 130. The memory 210 may include one or more memories and/or other program and data storage devices, for example, for storing instructions executable by the CPU 208.

The example home gateway 110 also includes a user I/O interface 212. The user I/O interface 212 may include an electroluminescent (EL), liquid crystal device (LCD), or light emitting diode (LED) display for displaying information to the user watching the DTV device 116. The user I/O interface 212 may also include an infrared (IR) receiver for receiving instructions from the user's remote control. Although not shown, this IR receiver may be implemented as an IR transceiver and provide a communication channel for sending and receiving short-range optical communications between the home gateway and one or more of the CPE devices 114, 116, 118, 120, 122, 124 and 126.

In an example of the operation of the home gateway 110 shown in FIGS. 1 and 2, the user of mobile device 122 may transmit, via WiFi access point 214 and local network adaptor 206, a wireless signal, instructing home gateway 110 to retrieve media content (e.g. a TV show) from a content provider (e.g. a streaming video service) coupled to the ESO 130. In response, the CPU 208 sends a request for this media content to the ESO 130 via cable interface 204 and the cable input line 128. CPU 208 may then receive the requested media content, a meta-data file associated with the media content, and an indicator of whether the meta-data file should be utilized to facilitate reproduction of the media, from the content provider. The received media content, meta-data file and indicator are then transmitted to the mobile device 122 via local network adaptor 206 and WiFi access point 214. In response to receiving the indicator, the CPU of the smartphone 122 may extract the identifier from the meta-data file to identify and reproduce the media content based on the information in the meta-data file.

Content may be reproduced upon receipt. Alternatively, it may be stored, either in the memory 216 of the home gateway 110, in the memory (not shown) of one of the CPE devices, or in the NAS device 114, and reproduced at a later time. By way of an example, at a later point in time, when the user wishes to reproduce the media content on the DTV 116, a remote control device (not shown) associated with the home gateway 110 or DTV 116, sends a request for the media content to the home gateway 110 via the user I/O connection 212. Assuming that the home gateway 110 has stored the requested the media content from a previous download in the NAS device 114, the CPU 208 of the home gateway retrieves the media content, associated meta-data file and indicator from the WAP device 114 and sends media content, associated meta-data file and indicator via TV interface 202 to the DTV 116. DTV 116 may then reproduce the media content based on the information in the meta-data file For example, if the meta-data file includes information on trick play (e.g. Fast Forward and Rewind), by using the remote control, the user will be able to skip specific frames in the video (as instructed by the meta-data file) to allow the user to perform trick play on the video.

As described above, the home gateway 110 receives data from the ESO 130 as well as from each of the CPE devices 114, 116, 118, 120, 122, 124 and 126. The CPU 208 may monitor the received data to automatically identify error conditions or issues that may affect the user's experience. For example, the home gateway 110 may detect a specific error code, a reduced quality of service (QoS) or a loss of connection with the ESO 130 as an error condition or issue. The CPU 208 of the home gateway 110 may detect the error code or issue either from one of the CPE devices or from other circuitry in the gateway 110.

Each of the CPE devices 114, 116, 118, 120, 122, 124 and 126 coupled to the home gateway 110 may use a predetermined protocol. This protocol may be, for example, IEEE 802.11 WiFi, Universal Plug and Play Device Management (UPnP DM), IEEE 1394 FireWire, IEEE 802.15 (e.g. WPAN, Bluetooth, Bluetooth Low Energy (BLE), Zigbee, Zigbee RF4CE etc.) or other data exchange protocol. The protocol may determine how information about the CPE device, such as codes indicating a particular manufacturer, model number and serial number, may be obtained. For example, this device information may be provided 1) automatically when the device is connected, or 2) in response to a device discovery request provided by the home gateway 110 or ESO server 134. The CPU 208 may store the device information—either locally in the memory 210 or NAS device 114 or remotely in the server 134—for use, as described below, to provide the user with information as to how to correct a detected error or issue with one of the CPE devices. As described below, when the home gateway 110 is first powered up and coupled to the ESO 130, a new CPE device is detected, the system may automatically obtain on-line user manuals and/or service data for the gateway or device from the network server 134 or the Internet and store the obtained information in the memory 210 or NAS device 114. In addition, the home gateway 110 may detect a new CPE device when it is first connected to the gateway 110. Upon detection, the system may obtain on-line manuals for the new CPE device.

A search for on-line manuals and/or service data may, for example, be an Internet search based on a formulated query including the manufacturer, model number and the word “manual,” “service bulletin,” “trouble-shooting,” and/or “download.” The entity performing the search, either the home gateway 110 or the server 134, may limit its search to results having a domain name associated with the manufacturer. For technical manuals, it may identify the manual as a document available on the site and having the word “manual” in the title and being in portable document format (pdf). Similarly, it may look for documents containing the words “service bulletin” and/or “trouble-shooting.” In this example, the manuals and other service documents are automatically retrieved and stored, for example, in the NAS device 114 on the home network or on the network server 134.

At some point during its normal operation, the home gateway may become disconnected from the ESO 130 or may be unable to access the Internet via the ES) 130. In anticipation of these events, the home gateway 110, when it is first powered up and detects Internet access, may search for and download diagnostic and repair information regarding errors or issues related to the loss of connection to the ESO 130 or the loss of Internet access. These results may be obtained by automatically formatting a search query such as “lost cable connection” or “No Internet connection” and processing the results, as described above. The content of the webpages identified in the search may be downloaded and stored in a local memory device such as the NAS device 114. Because the relevant information may not be directly accessible from the first webpage, the system may download not only the webpages identified in the search but webpages accessible from that page as well. These webpages may be stored so that they can be accessed locally by a browser internal to the home gateway 110.

The protocol between each CPE device and the home gateway 110 may also include a facility that determines how consumer alerts (e.g. errors and issues) are reported by the device when they are detected. These errors may be reported, for example as error codes sent in a control field of a message header, in response to a status request or as a part of a response to a data request. The error codes may be detected by the CPU 208 of the home gateway as a part of the data communication between the home gateway 110 and the CPE device. In addition to the error codes, the home gateway 110 may monitor communications with the various CPE devices to determine when the communication channel has become degraded. For example, if WiFi communications may be adversely affected by a near-by radio source such as a microwave oven or Bluetooth communications may be adversely affected by the location of the CPE device relative to the Bluetooth transceiver 216. The CPU 208 may detect other issues with the signals received from the CPE devices, such as an increase in bit-error-rate (BER) or other indication in a reduction in quality of service (QoS). Furthermore, the home gateway may detect an invalid network configuration, for example, when it sends a message to a CPE device and receives an invalid response.

The example method and apparatus use the information on the error or issue with the gateway or CPE device along with the stored device information to automatically search—either a global information network, such as the Internet, or a local website—for information on how the user can address the issue. This information may be, for example, in the form of instructional videos, user's manuals, manufacturer tech-support sites, diagnostic sites, or question-and-answer sites, among others. In the materials that follow, reference to a “site” or a “link” may include a website registered with a domain name server (DNS) or a webpage within such a site indicated by such a link. It may also refer to a web-page local to the server 134 to the home gateway 110 and/or NAS device 114. The site or link may also be a hyperlink to a document, video or multi-media content item stored on the server 134, in the memory 210 or in the NAS device 114.

FIG. 2A is a block diagram of an example mobile device 122. The mobile device includes a touch-screen display 268 for displaying application screens, messages, menus or the like and for receiving input selections such as dialed numbers and web page navigation. A keypad 280 includes a limited number of keys that perform functions such as power-on/off, sound volume adjustments and other functions of the device.

A microprocessor 262 serves as a programmable controller for the mobile device 122, in that it controls all operations of the mobile device 122 in accord with programming that it executes, for all operations. In the example, the mobile device 122 includes flash type program memory 274, for storage of various “software” or “firmware” such as an operating system and application programs. In addition the memory 274 may hold mobile configuration settings, such as mobile directory number (MDN) and/or mobile identification number (MIN), etc. The mobile device 122 may also include a non-volatile random access memory (RAM) 266 for a working data processing memory.

The example mobile device 122 further includes a microphone 252, speaker 254 and vocoder 256 for audio input and output functions. The device 122 also includes at least one digital transceiver (XCVR) 258, for digital wireless communications and at least one short-range transceiver 276, shown in the example as a WiFi transceiver, to communicate with the home gateway 110 and the network gateway 132 via the WiFi access point 214. The transceiver 258 provides two-way wireless communication of information, such as vocoded speech samples and/or digital information, in accordance with the technology of the telecommunications network. Each transceiver 258 and 276 connects through RF send and receive amplifiers (not separately shown) to a respective antenna 260 and 278, although it is contemplated that both transceivers could use a single antenna. The transceiver 258 may also support various types of mobile messaging services, such as short message service (SMS), enhanced messaging service (EMS) and/or multimedia messaging service (MMS) and may include a web browser for interacting with websites either through the telecommunications transceiver 258 or the short-range transceiver 276.

The user interface of the exemplary mobile device 122 includes a display 268, which the microprocessor 262 controls via a display driver 264, to present visible outputs to the device user. The user interface also includes a touch/position sensor 270 that overlies the display 268 and is relatively transparent, so that the user may view the information presented on the display 268. A sense controller 272 senses signals from elements of the touch/position sensor 270 and detects occurrence and position of each touch of the screen formed by the display 268 and sensor 270. The sense controller 272 provides touch position information to the microprocessor 262, which can correlate that information to the information currently displayed via the display 268, to determine the nature of user input via the sensor 270.

Referring to FIG. 1, the user may configure the alert facility to indicate preferences for receiving the alerts about the detected errors or issues in CPE devices coupled to the home network. For example, the alert facility may be activated by selecting a menu entry in the control menu (not shown) for the home gateway 110. This menu may be displayed on the DTV 116, mobile device 122 or computer 124 in response to a request from the user entered via the remote control device, the mobile device 112 or computer 124, respectively. In one example, selecting the error reporting menu entry may bring up a sub-menu that allows the user to enable/disable the alert facility and to customize it. When the “customize” option is selected, yet another sub-menu may be displayed, allowing the user to enter information about the types of information to be provided by the system and how the information is to be provided. The selection of the types of information may include a check-list including multiple entries such as “How-To Videos,” “Tech Support Sites,” “User Manuals,” “Blogs” and “Question and Answer Sites.” Any entries checked-off by the user would be added to the preferred list of types of sites to be provided in response to a detected error or issue. The selection of how the information is to be provided may allow the user to select a device on which the alert is to be displayed, for example on the DTV 116, mobile device 122 or computer 124. This menu may also allow the user to specify a primary display device and a secondary display device. The secondary display device may be used if the identified error is in the primary display device or if the primary display device cannot be accessed by the home gateway 110. The configuration menu may also allow a user to specify how the alert is to be received when a particular device is selected. For example the user may select the alert to be sent as an SMS message or as an e-mail when the mobile device 122 is selected to receive the alert,

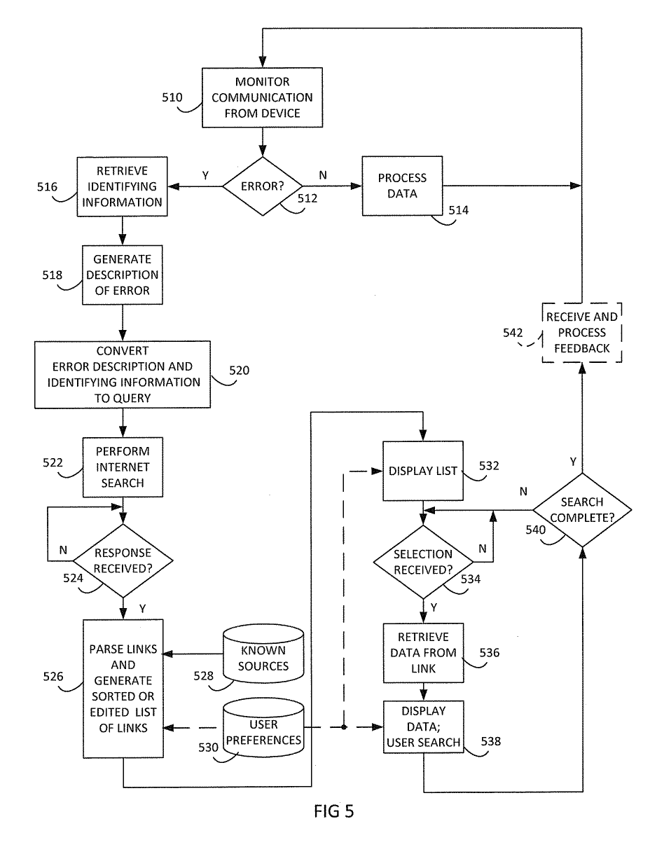

As an alternative to the menu system shown in FIG. 4, the consumer alert system may be configured by using the DTV 116 or computer 124 to access a portal webpage that is either at a known Internet address or local to the network server 134. This webpage may display a menu, similar to that described above, or provide a graphical display of the home network (not shown) allowing the user to select the gateway or one of the CPE devices to specify the type of information to be obtained and stored for each device as well as the types of websites to be provided to the user when an error or issue is detected.

Three embodiments of the example method and apparatus are described below. The first embodiment uses the home gateway 110 and the server 134 of the ESO 130. This embodiment is described with reference to FIGS. 1 and 5. FIG. 5 is a flow-chart diagram of software running, at least partially, on the home gateway 110 that configures the gateway 110 to monitor communications among the gateway and the various CPE devices. At step 510, the home gateway 110 receives data from the CPE devices according to the various protocols used by the devices. At step 512, the gateway 110 determines whether the communication identifies an error or is evidence of an issue. The gateway 110 may, for example, access an error field specified in each protocol or may receive information on the signal quality of the communication along with the data. When no error or issue is detected, then step 514 processes the communication and control returns to step 510. When, however, step 512 identifies an error or issue, step 516 is executed to generate a description of the error or issue. For example, the DTV may report an error code “E214.” In this embodiment, the home gateway 110, at step 516 retrieves the stored information about the DTV 116. As described above, this information may have been previously stored by the gateway 110. For example, the home gateway 110 determines that the DTV device is model number “MV20134567” manufactured by “Acme Electronics.”

At step 518, the home gateway 110 generates a description of the error. In this example, the description may be “error code E214.” Rather than just using the returned error code—the gateway 110 may generate an initial search query to determine more information about the error by combining the information about the DTV device with the description of the error. For example, the “Acme Electronics model MV21034567 error code E214” to determine if specific information about the error may be available. The gateway 110 may perform the search, for example, by consulting the manuals and service data that were obtained when the DTV device was first detected by the gateway 110, as described above. Alternatively, a description of the error may be obtained by entering the search query into one or more search facilities, such as an Internet search engine, such as Goggle® or Bing® or for a search tool in the stored manual for the DTV device 116. At step 518, the gateway 110 may then parse the results for definitional language. For example, one of the results may contain a character string such as “error code: E214—loss of audio signal.” The colon following “error code” may indicate that the material following the colon is a definition of the error code. Alternatively or in addition, other techniques may be used to identify a definition such as the word “definition” or “glossary” appearing on a page heading or by a dash separating the error code from the text string. Thus, the gateway 110, at step 518, may parse the returned search result to generate a description of the error such as “loss of audio signal.” If no definitional language is detected in the search results, the gateway 110 may retain the description as “error code E214.” At step 520, the home gateway 110 combines the device description data and the description of the error into a formatted search query, for example, “Acme Electronics model MV21034567A loss of audio signal.” In this embodiment, the search string is sent to the server 134.

The server 134, at step 522, then submits the search query to one or more search facilities such as an Internet search engine accessed through a browser program and/or to the search engine of the manual for the DTV device 116 which has been pre-stored at the network server 134. At step 524, the server 134 waits to receive the response and extracts the text and any corresponding links from the returned results. At step 526, the server 134 parses the text and links to generate a sorted list of text and links for presentation to the user. In generating the list, the server 134 may first edit the list to remove all sponsored links and links to other search engines. It may then consult two databases, a database of known sources 528 and a database of user preferences 530. The database of known sources 528 includes the domain names of trusted sites that have been used in the past or that have been certified as providing useful information. For example, some sites, such as YouTube® may be known to provide instructional videos. The database of user preferences 530 includes the menu selections entered by the user on initiating the alert facility, as described above. For example, the user may have indicated a preference for instructional videos and tech-support sites. If one of the results includes such a domain, the search result may be preserved for presentation to the user. In response to the user preferences, the server 134, at step 526 may rank any identified instructional videos and/or tech-support sites higher in the list than other results returned in the search.

At step 532, the server 134 formats the sorted list and sends it to the gateway 110 for display to the user. The list may be formatted, for example, with a header such as “Error E214—loss of audio signal, has been reported by the Acme Electronics Digital Television Receiver. Please consult the following for more information.” This heading may be followed with a formatted list of links Each link may be formatted, for example, by removing extraneous text, providing only the description and the associated link. Alternatively, the link may be renamed to coincide with the description so that the selection of the description by the user activates the link. In step 532, the gateway 110 consults the user preferences database 530 to determine the device on which the user would prefer to receive the results. As described above, the user may indicate a preferred display device or, alternatively, primary and secondary display devices. In this instance, the user may have indicated the DTV 116 as the primary display device and the mobile device 122 as the secondary display device. In this example, the home gateway 110 determines that the error is in the DTV device and routes the list to the secondary device. Thus, the gateway 110 sends a message to the mobile device 122, using the network adaptor 206 and the WiFi access point 214. This message may cause the mobile device to run an application associated with the alert facility. The application displays the formatted list and the home gateway 110 provides an Internet browser function that allows the user to access the links in the displayed list. Alternatively, the home gateway may send the formatted list to the network gateway 132 with instructions to send it to the mobile device 122 via the telecommunications gateway 136, for example, as one or more short messaging service (SMS) messages.

As an alternative to providing the most pertinent link or list of links to the user, the network server 134 may build a local web page containing the parsed information from the search and send a link to the web page to the user via the network interface. The user can then access the diagnostic information using this web-page.

When the user employs the browser function in the home gateway to access the information, at step 534, the home gateway 110 waits to receive a selection from the user. At step 536, it receives the selection and retrieves the data associated with the link. At step 538 it displays the data associated with the link and allows the user to scroll through the data to search for a solution to the identified problem. The browser function in the gateway 110 may suppress any advertisements in the displayed site data so as not to distract the user. In one embodiment, the browser may frame the sites as they are accessed to ensure that the user may not be directed away from the error reporting application in the home gateway 110. Alternatively, as described above, the mobile device 122 may access the links without using the home gateway 110, for example, through a browser resident on the mobile device 122 and an Internet connection established by the mobile device 122 through the telecommunications gateway 136 and the network gateway 132.

The user may access multiple links from the list as indicated at step 540. Once the user indicates that the search is complete, control transfers to optional step 542 at which the user may provide feedback on the value of the links. This may be done, for example, by displaying the list of links where each link such that each link may be associated with multiple checkboxes each checkbox corresponding to a respective rating value, for example, good, fair and poor. In this embodiment, the home gateway 110 may send the ranked list, including the ratings, to the server 134. The server 134 may use these rankings to refine the database of known sources 528 to add a site to or delete a site from the database or to adjust how the sites returned from the search are ranked. Any such modification may require multiple good ratings or multiple bad ratings to make any modification to the sources in the list in order to reduce the effects of outliers.

After the search is complete and, optionally, after the feedback has been processed, control returns to step 510 to continue to monitor communications in the home network environment.

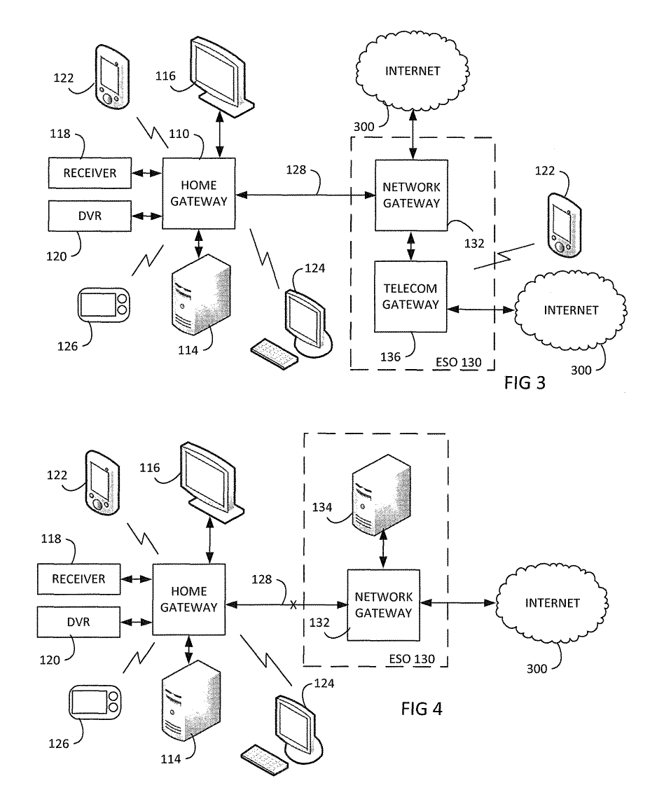

The second embodiment, described with reference to FIGS. 3 and 5, is similar to the first except that the steps performed by the server 134 in the first embodiment are performed by the home gateway 110. Thus, the second embodiment differs from the first embodiment in that steps 522, 524 and 526 are performed by the processor 208 of the gateway 110 instead of the server 134. Furthermore, the databases 528 and 530 are maintained by the home gateway 110 and stored in either the memory 210 or in the NAS device 114.

The operation of the alert facility for the second embodiment is described with reference to a specific example. In this example, the home gateway 110 senses an error when purchase request for a pay-per-view event is refused. The home gateway 110, at step 518 senses an error code corresponding to the refusal and, at step 520, translates this error code to the following internet search query string: “Cannot purchase pay per view.” In this instance, a particular streaming service refused the request. Because this error code is one that may be expected to occur when using the home gateway 110, the gateway may have a pre-stored text string corresponding to the error code that is used for all streaming services. Alternatively, a content server (not shown) on the network that supports the streaming service may send the error message to the home gateway 110 and the gateway may search the Internet for tech-support literature related to the streaming service to determine the meaning of the error code.

Because this error is not related to any of the devices in the network, the device information determined at step 516 is not relevant. At step 522, the home gateway 110 submits the query to the search facility (e.g. Google or Bing) At step 526, after the response is received, the home gateway obtains the Internet search results shown in Table 1:

TABLE 1

Why can't I order Pay-Per-View programming?:
PPV Customer Support | Time Warner Cable Pay-Per-View
Video On Demand and Pay Per View - FiOS TV Customer
Purchasing Pay-Per-View Events and Subscription Programs

Each of the results shown in Table 1 is or includes a link to a website. The home gateway 110 parses the above internet search results and determines that the best site to use would be “Why can't I order Pay-Per-View programming?” In the example, this decision was made by finding the best match between the words in the internet site description and the query description.

The home gateway 110, at step 532, retrieves the “preferred communication method” chosen by the user from the user preferences database and determines that a text message is to be sent to the mobile device 122. The home gateway obtains the phone number of the mobile device 122 from the previously stored device information. Alternatively, the home gateway may obtain this information via a device discovery request, using the network adaptor 206 and either the WiFi access point 214, the Bluetooth transceiver 216, NFC transceiver 216 or Zigbee RF4CE transceiver 219. The home gateway 110 next identifies the address of the head-end server 132 of the ESO 130 that has the capability of sending a text message to a mobile device. The home gateway 110 then sends a message to the ESO head-end server 132 and includes the alert notification as the body of the text message and the mobile device phone number. Head-end server then sends the link in a message to the mobile device 122, for example, as an email message or a MSM message through the telecom gateway 136. The user receives the alert notification via phone communication over the 4G network. In this instance, the user accesses the internet through the 4G service and the telecom gateway 136 to obtain the data from the link. At step 536, the user reads the information from the link to help diagnose and solve the problem and, optionally, rates the result, as described above.

The third embodiment is described with reference to FIGS. 4 and 5. In this embodiment, there may be a break in the network connection 128 between the home gateway 110 and the network gateway 132, as indicated by the “x.” Because of this break, the home gateway 110 does not have access to the ESO or the Internet. In this instance, the home gateway 110 may access locally-stored materials, such as the manuals and diagnostic and repair webpages obtained and stored in the NAS 218, as described above. In order to keep an interface similar to that shown in the first two embodiments, the home gateway 110 may maintain a local website (e.g. an intranet) with links to the stored manuals, webpages and other information on the CPE devices and lost connections. These webpages may be configured to be accessible via links from the local website. In this embodiment, the browser function of the home gateway 110 may access the website using a search engine of the website instead of the commercial search engine such as Google or Bing.

The operation of the third embodiment is described with reference to a specific error, the loss of the network connection 128. In this example the home gateway 110 has detected the loss of connection to the ESO 130. At step 518, the home gateway 110 generates a text description of the error, for example, “lost cable connection.” It then combines this with descriptive information concerning the home gateway, such as the manufacturer and model number, at step 520, into a query text string. Next, at step 522, the gateway 110 submits the query string to the search engine of the local website or database containing the pre-stored manuals and service documents for the CPE devices on the home network. As described above, this database may be stored in the NAS device 114 or the memory 208 of the home gateway 110. At step 524, the home gateway 110 receives the response and, at step 526, it parses the response to identify the best information to provide to the user. In this example, the home gateway 110 receives the sites listed below in Table 2.

TABLE 2

Guide to Fixing Lost Connection and Speed Issues
Lost Connection to the Internet
Troubleshooting Lost Internet Connection

At step 532, the home gateway 110 displays all three links on the user preferred display device, the DTV 116. At step 534, the gateway receives a selection of the first link and, at steps 536 and 538, retrieves and displays the information obtained by following that link in the local website or database of the gateway 110. The user then searches through the displayed information for suggestions as to how to fix the lost cable connection. If the user is not satisfied with this information, step 540 indicates that the search is not complete and control returns to step 534 while the process waits for the user to select another entry from the list. Once the last entry in the list has been processed or the user, at step 540, indicates that the search is complete, control transfers either to option al step 542 to receive feedback or to step 510 to continue to monitor communications among the home gateway 110 and the CPE devices to identify errors or issues.

Aspects of the methods of the exemplary apparatus and method outlined above may be embodied in programming, e.g. in the form of software, firmware, or microcode executable by a user computer system, a server computer or other programmable device. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the ESO 130 into the memory 210 of the home gateway 110. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to one or more of “non-transitory,” “tangible” or “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-transitory storage media include, for example, optical or magnetic disks, such as any of the storage devices in any computer(s) or the like. It may also include storage media such as dynamic memory, for example, the main memory of a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and light-based data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Program instructions may comprise a software or firmware implementation encoded in any desired language. Programming instructions, when embodied in machine readable medium accessible to a processor of a computer system or device, render computer system or device into a special-purpose machine that is customized to perform the operations specified in the program.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical or similar elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A device alert system comprising:
a home gateway for a home network, the home gateway including:
a plurality of communications channels for coupling the home gateway to a plurality of customer premises equipment (CPE) devices wherein the plurality of CPE devices includes a display device;
a processor, coupled to the plurality of CPE devices via the plurality of communications channels;
a memory including:
software that configures the processor to monitor communications among the plurality of CPE devices to automatically determine that one of the CPE devices or the home gateway has an error or has an issue and to generate a textual description of the error or issue;
software that configures the processor to automatically generate a search query by combining the textual description of the error or issue with a textual description of the one CPE device or home gateway;
software that configures the processor to send the query to a search facility;
software that configures a processor coupled to the display device to receive from the search facility one or more search results that causes the display device to display the one or more search results; and,
software that, in response to receiving a selection of one of the search results, configures the processor coupled to the display device to retrieve and display data corresponding to the selected search result on the display device.

2. The device alert system of claim 1, wherein:
the search facility includes a network server coupled to the home gateway via a network connection, network server including:
a browser that receives the search query and provides the search query to a search engine to perform an Internet search and receives the search results in response to the Internet search;
software that configures the network server to process the received search results to automatically identify the one or more search results to be presented on the display device by matching the search results to the query; and
software that formats the processed search results into a list and provides the formatted list for display on the display device.

3. The device alert system of claim 2, wherein:
the display device is a mobile device coupled to the network server via a telecommunications network and to the home server via a short-range communications channel;
the processor coupled to the display device is a processor of the mobile device; and
the network server further includes software that transmits the list of formatted search results to the mobile device via the telecommunications network.

4. The device alert system of claim 1, wherein:
the display device includes a processor, a memory and a network interface; and
the data that causes the display device to display the one or more search results includes a link to a website containing the search results.

5. The device alert system of claim 1, wherein:
the display device is in a computing device that is configured to receive email messages; and
the data that causes the display device to display one or more search results includes an email message containing the one or more search results.

6. The device alert system of claim 1, wherein the software that configures the processor to monitor communications among the plurality of CPE devices to automatically determine that one of the CPE devices or the home gateway has the error or issue further comprises software that configures the processor to cause a notification of the detected error or issue to be displayed to the user on the display device.

7. The device alert system of claim 1, wherein:
the memory of the home gateway includes the search facility which includes:
a browser that receives the search query and provides the search query to a search engine to perform an Internet search and receives the search results from the Internet search;
software that configures the processor of the home gateway to process the received search results to automatically identify the one or more search results to be presented on the display device by matching the search results to the query; and
software that configures the processor of the home gateway to format the processed search results into a list, ranked according to predetermined preferences and provides the formatted list for display on the display device.

8. The device alert system of claim 1, wherein the software that configures the processor to generate the textual description of the error or issue further includes software that searches one of a local database on the home network and the Internet for a definition of the error or issue and, upon receiving a search result including the definition, generates the textual description of the error or issue including the definition.

9. The device alert system of claim 1, wherein each of the communications channels communicates with at least one of the CPE devices according to a predetermined protocol including an error reporting facility and the processor of the home gateway monitors communications among the plurality of CPE devices by receiving error messages from each of the error reporting facilities.

10. The device alert system of claim 9, further including software that configures the processor of the home gateway to detect when a new CPE device is added to the home network and, in response to the detection, obtain information identifying the CPE device using the respective protocol for the CPE device.

11. The device alert system of claim 10 wherein the software that configures the processor to obtain information identifying the new CPE device automatically initiates a search for manuals or tech support documentation for the new CPE device, obtains any manuals or tech support documentation identified in the search and stores the obtained manuals or tech support documentation in a memory of one of the CPE devices coupled to the home network or in the memory of the home gateway.

12. The device alert system of claim 1, further including:
a first database holding the predetermined user preferences and a second database holding predetermined information on sites containing diagnostic information; and
the memory of the home gateway further includes software that configures the processor of the home gateway to receive ratings of each of the search results and to modify the second database based on the received ratings; wherein the second database is used by the search facility to process the search results by ranking the search results according to the respective ratings of the sites in the database.

13. A method for providing device alerts in a home network including a home gateway and a plurality of customer premises equipment (CPE) devices coupled to the home gateway, wherein each of the CPE devices exchanges data with the home gateway according to a respective predetermined protocol, the method comprising:
determining, by a processor of the home gateway, whether a data exchange between the home gateway and one of the CPE devices indicates an error or issue according to the respective predetermined protocol;
automatically generating, by the processor of the home gateway, a search query by combining a textual description of the indicated error or issue with a textual description of the one CPE device;
submitting the generated search query to a search facility, to identify diagnostic information concerning the indicated error or issue;
receiving, from the search facility, results including one or more search results relevant to the search query;
formatting the one or more results received from the search facility, wherein the one or more results are arranged in order of relevance to the search query;
receiving, by the processor of the home gateway, a selection of one of the one or more results and retrieving and displaying data corresponding to the selected search result on a display device coupled to the home gateway.

14. The method of claim 13, wherein the search facility includes a network server coupled to the home gateway via a network connection, and the method further includes:
receiving the search query by a browser of the network server and performing an Internet search using the search query;
receiving, by the network server, search results from the Internet search;
automatically identifying, by the network server, the one or more search results to be presented to the user by matching the search results to the query; and
formatting, by the processor of the home gateway, the one or more search results into a list and displaying the formatted list on a display device coupled to the home gateway.

15. The method of claim 13, further comprising: ranking, by the network server, the identified search results according to predetermined user preferences before displaying the formatted list.

16. The method of claim 15, wherein the home network further includes a first database holding the predetermined user preferences and a second database holding predetermined information on sites containing diagnostic information, and the method further includes receiving, by the processor of the home gateway, ratings of each of the search results and modifying the second database based on the received ratings; wherein the second database is used by the search facility to process the search results by ranking the search results according to the respective ratings of the sites in the database.

17. The method of claim 13, wherein the search facility is internal to the home gateway, and the method further includes
receiving the search query by a browser of the home gateway and performing an Internet search using the search query;
receiving, by the processor of the home gateway, search results from the Internet search;
automatically identifying, by the processor of the home gateway, the one or more search results to be presented to the user by matching the search results to the query; and
formatting, by the processor of the home gateway, the one or more search results into a list and displaying the formatted list, ranked according to predetermined user preferences, on a display device coupled to the home gateway.

18. The method of claim 13 further including:
detecting, according to one of the predetermined protocols, when the home gateway or a CPE device is first powered up on the home network and, in response to the detection:
obtaining information identifying the home gateway or CPE device using the respective protocol for the home gateway or CPE device;
initiating a search for manuals and tech support documentation for the home gateway or CPE device;
obtaining any manuals and tech support documentation identified in the search; and
storing the obtained manuals and tech support documentation in a memory of one of the CPE devices coupled to the home network or in a memory of the home gateway.

19. The method of claim 19, further including:
upon detecting a first connection to the Internet and initiating a search for manuals and tech support document information relevant to a loss of connection to the Internet; and
storing the obtained manuals and support documentation relevant to the loss of connection to the Internet in a memory of one of the CPE devices or in the memory of the home gateway.

20. A device alert system comprising:
a display device;
a memory device; and
a set-top gateway, configured to communicate with a network to provide content from the network to the display device and to the memory device, the set-top gateway including:
a processor;
a plurality of communication channels, coupled to the processor, the communication channels being configured to send data to and receive data from a plurality of customer premises equipment (CPE) devices including the memory device and the display device according to a respective protocol; and
a memory including:
software that configures the processor to receive data from the plurality of communication channels and, based on the received data and the respective protocol, to automatically determine that an error has occurred in one of the CPE devices and to generate a textual description of the error;
software that configures the processor to automatically retrieve information identifying the one CPE device from the data received from the one CPE device or from the memory device and to convert the identifying information into a textual description of the one CPE device;
software that configures the processor to automatically generate a search query by combining the textual description of the error with the textual description of the one CPE device;
software that configures the processor to send the search query to a search facility;
software that configures the processor to receive a response to the search query from the search facility, the response including a plurality of links to a respective plurality of content items relevant to the error and to the CPE device;
software that configures the processor to automatically parse the plurality of links based on at least one of a) relevance to the error and the one CPE device or b) preferences indicated by a user to arrange the plurality of links into a list for presentation to the user; and
software that configures the processor to format the links for presentation to the user via the display device and, in response to receiving a selection of one of the links, retrieves and displays data corresponding to the selected link on the display device.
